(19) United States
(12) Patent Application Publication
(10) Pub. No.: US 2014/0069681 A1
(43) Pub. Date: Mar. 13, 2014

(54) ADHESIVE BACKED HYBRID CABLING FOR IN-BUILDING TELECOMMUNICATION AND WIRELESS APPLICATIONS

(71) Applicants: Stephen Paul LeBlanc, Austin, TX (US); Kurt H. Petersen, Austin, TX (US); Curtis L. Shoemaker, Round Rock, TX (US)

(72) Inventors: Stephen Paul LeBlanc, Austin, TX (US); Kurt H. Petersen, Austin, TX (US); Curtis L. Shoemaker, Round Rock, TX (US)

(73) Assignee: 3M INNOVATIVE PROPERTIES COMPANY, St. Paul, MN (US)

(21) Appl. No.: 14/114,710

(22) PCT Filed: Apr. 24, 2012
(86) PCT No.: PCT/US2012/034773

§ 371 Date: Oct. 29, 2013

Related U.S. Application Data
(60) Provisional application No. 61/481,820, filed on May 3, 2011.

(51) Int. Cl. H02G 3/04

(52) U.S. Cl. CPC H02G 3/04
USPC 174/95

(57) ABSTRACT

An adhesive-backed hybrid cabling duct comprises a main body having at least one conduit portion with a bore formed throughout that is sized to accommodate one or more communication lines disposed therein. The duct also includes a flange to provide support for the duct as it is mounted to a mounting surface, wherein the flange includes a channel formed therein configured to receive a substantially rectangular-shaped cable. The duct also includes an adhesive layer to mount the duct to the mounting surface. The adhesive-backed hybrid cabling duct provides for multiple channels of RF/cellular traffic to be distributed to different locations within a building.

### BACKGROUND OF THE INVENTION

1. Field of the Invention

The present invention is directed to adhesive-backed hybrid cabling for in-building telecommunications and in-building wireless (IBW) cabling applications.

2. Background

Several hundred million multiple dwelling units (MDUs) exist globally, which are inhabited by about one third of the world's population. Due to the large concentration of tenants in one MDU, Fiber-to-the-X (“FTTX”) deployments to these structures are more cost effective to service providers than deployments to single-family homes. Connecting existing MDUs to the FTTX network can often be difficult. Challenges can include gaining building access, limited distribution space in riser closets, and space for cable routing and management. Specifically, FTTX deployments within existing structures make it difficult to route cables within the walls or floors, or above the ceiling from a central closet or stairwell, to each living unit.

Conventionally, a service provider installs an enclosure (also known as a fiber distribution terminal (FDT)) on each floor, or every few floors, of an MDU. The FDT connects the building riser cable to the horizontal drop cables which run to each living unit on a floor. Drop cables are spliced or otherwise connected to the riser cable in the FDT only as service is requested from a tenant in a living unit. These service installations require multiple reentries to the enclosure, putting at risk the security and disruption of service to other tenants on the floor. This process also increases the service provider's capital and operating costs, as this type of connection requires the use of an expensive fusion splice machine and highly skilled labor. Routing and splicing individual drop cables can take an excessive amount of time, delaying the number of subscribers a technician can activate in one day, reducing revenues for the service provider. Alternatively, service providers install home run cabling the full extended length from each living unit in an MDU directly to a fiber distribution hub (FDH) in the building vault, therefore encompassing both the horizontal and riser with a single extended drop cable. This approach creates several challenges, including the necessity of first installing a pathway to manage, protect and hide each of the multiple drop cables. This pathway often includes very large (e.g., 2 inch to 4 inch to 6 inch) pre-fabricated crown molding made of wood, composite, or plastic. Many of these pathways, over time, become congested and disorganized, increasing the risk of service disruption due to fiber bends and excessive re-entry.

Better wireless communication coverage is needed to provide the desired bandwidth to an increasing number of customers. Thus, in addition to new deployments of traditional, large “macro” cell sites, there is a need to expand the number of “micro” cell sites (sites within structures, such as office buildings, schools, hospitals, and residential units). In-Building Wireless (IBW) Distributed Antenna Systems (DASs) are utilized to improve wireless coverage within buildings and related structures. Conventional DASs use strategically placed antennas or leaky coaxial cable (leaky coax) throughout a building to accommodate radio frequency (RF) signals in the 300 MHz to 6 GHz frequency range. Conventional RF technologies include TDMA, CDMA, WCDMA, GSM, UMTS, PCS/cellular, iDEN, WiFi, and many others.

Outside the United States, carriers are required by law in some countries to extend wireless coverage inside buildings. In the United States, bandwidth demands and safety concerns will drive IBW applications, particularly as the world moves to current 4G architectures and beyond.

There are a number of known network architectures for distributing wireless communications inside a building. These architectures include choices of passive, active and hybrid systems. Active architectures generally include manipulated RF signals carried over fiber optic cables to remote electronic devices which reconstitute the electrical signal and transmit/receive the signal. Passive architectures include components to radiate and receive signals, usually through a punctured shield leaky coax network. Hybrid architectures include native RF signal carried optically to active signal distribution points which then feed multiple coaxial cables terminating in multiple transmit/receive antennas. Specific examples include analog/amplified RF, RoF (Radio over Fiber, also known as RFoG, or RF over glass), fiber backhaul to pico and femto cells, and RoF vertical or riser distribution with an extensive passive coaxial distribution from a remote unit to the rest of the horizontal cabling (within a floor, for example). These conventional architectures can have limitations in terms of electronic complexity and expense, inability to easily add services, inability to support all combinations of services, distance limitations, or cumbersome installation requirements.

Conventional cabling for IBW applications includes RADIAFLEX™ cabling available from RFS (www.rfsworld.com), standard ½ inch coax for horizontal cabling, ⅞ inch coax for riser cabling, as well as, standard optical fiber cabling for riser and horizontal distribution.

Physical and aesthetic challenges exist in providing IBW cabling for different wireless network architectures, especially in older buildings and structures. These challenges include gaining building access, limited distribution space in riser closets, and space for cable routing and management.

### SUMMARY

According to an exemplary aspect of the present invention, an adhesive-backed hybrid cabling duct comprises a main body having at least one conduit portion with a bore formed throughout that is sized to accommodate one or more communication lines disposed therein. The duct also includes a flange to provide support for the duct as it is mounted to a mounting surface, wherein the flange includes a channel formed therein configured to receive a substantially rectangular-shaped cable. The duct also includes an adhesive layer to mount the duct to the mounting surface.

In one aspect, the substantially rectangular-shaped cable comprises a substantially flat ribbon cable.

In one aspect, the main body and flange portion are formed from a polymer. In a further aspect, the polymer is a polymer that is extruded over the one or more communication lines.

In another aspect of the invention, an adhesive-backed hybrid cabling duct comprises a main body having at least one conduit portion with a bore formed throughout that is sized to accommodate one or more communication lines disposed therein. The duct also includes a flange to provide support for the duct as it is mounted to a mounting surface. The duct also includes a substantially rectangular-shaped cable disposed between the flange and the mounting surface. The duct also includes an adhesive layer to mount the duct to the mounting surface.

In one aspect, the main body and flange portion are formed from a polymer. In a further aspect, the polymer is a polymer that is extruded over the one or more communication lines.

In another aspect, the duct includes more than one conduit portion. In another aspect, the one or more communications lines occupy 50% or less of the volume within the bore.

In another aspect, the one or more communication lines disposed in the bore comprise a plurality of optical fibers and wherein the rectangular cable comprises a ribbon cable comprising a plurality of electrical wires. In a further aspect, the plurality of optical fibers are configured to transmit RF signals having a transmission frequency range of from about 300 MHz to about 6 GHz. In another aspect, the one or more communication lines disposed in the bore comprise at least one electrical wire and wherein the ribbon cable comprises a plurality of optical fibers. In a further aspect, the one or more communication lines disposed in the bore comprise at least one Ethernet over twisted pair communication line.

In another aspect, a distributed system for in-building wireless applications comprises an adhesive-backed hybrid cabling duct. The duct includes a main body having at least one conduit portion with a bore formed throughout that is sized to accommodate one or more communication lines disposed therein, a flange to provide support for the duct as it is mounted to a mounting surface, wherein the flange includes a channel formed therein configured to receive a substantially rectangular-shaped cable, and an adhesive layer to mount the duct to the mounting surface. The one or more communication lines are configured to transmit RF signals having a transmission frequency range of from about 300 MHz to about 6 GHz.

In another aspect, a distributed system for in-building wireless applications comprises an adhesive-backed hybrid cabling duct. The duct includes a main body having at least one conduit portion with a bore formed throughout that is sized to accommodate one or more communication lines disposed therein, a flange to provide support for the duct as it is mounted to a mounting surface, a substantially rectangular-shaped cable disposed between the flange and the mounting surface, and an adhesive layer to mount the duct to the mounting surface. The one or more communication lines are configured to transmit RF signals having a transmission frequency range of from about 300 MHz to about 6 GHz.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1A is an isometric view of an exemplary duct in accordance with an aspect of the present invention.

FIG. 1B is an isometric view of the exemplary duct of FIG. 1A with a ribbon cable also included.

FIG. 1C is an isometric view of another exemplary duct in accordance with an aspect of the present invention.

FIG. 2 shows a schematic view of an exemplary MDU with the duct of the present invention installed.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to hybrid cabling for in-building telecommunications and/or in-building wireless (IBW) applications. The inventive cabling solutions described herein provide signal pathways that include standard fiber and copper-based wiring and radio frequency (RF) signal pathways for coaxial (coax) cables, optical fiber, and/or power distribution cabling. The adhesive-backed cabling is designed with a low impact profile for better aesthetics. The adhesive-backed cabling can provide for multiple channels of RF/cellular traffic to be distributed, enabling flexible network design and optimization for a given indoor environment.

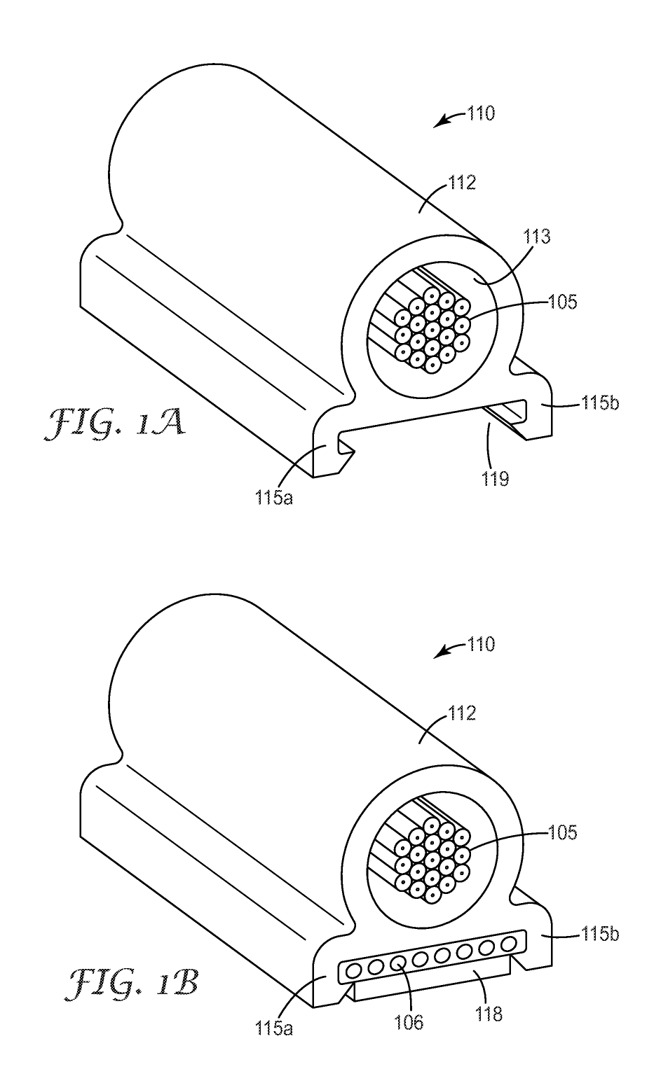

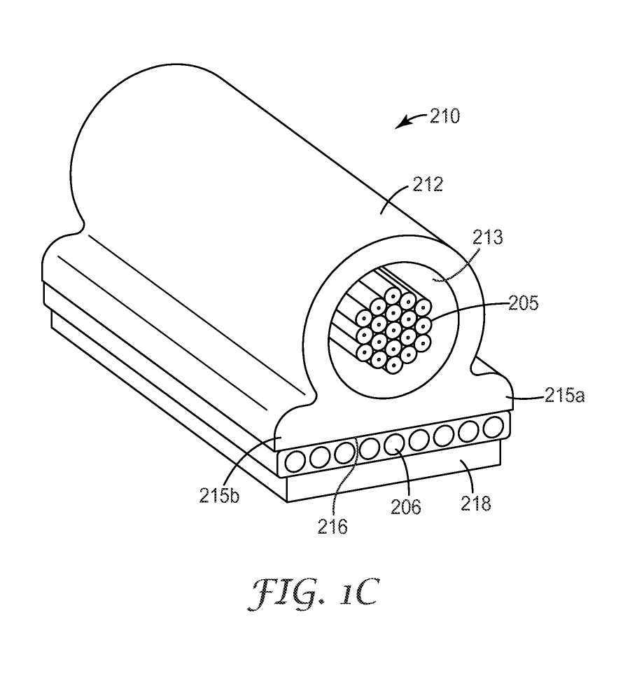

In a first aspect of the invention, as shown in FIG. 1A, an adhesive-backed cabling duct 110 accommodates one or more signal channels. As such, the adhesive-backed cabling duct 110 can provide horizontal cabling for general in-building applications, such as IBW applications. In other aspects, the adhesive-backed cabling duct 110 can provide cabling for inside living units in MDUs or other structures. As shown in FIG. 1A, duct 110 includes a main body 112 having a conduit portion with a bore 113 provided therethrough. The bore 113 is sized to accommodate one or more communication lines 105 disposed therein, depending on the type of application. These communication lines, as explained further below, can include coax cables, optical fibers, and/or power lines.

In the example of FIG. 1A, a plurality of optical fibers 105 are disposed in bore 113. In use, the duct 110 can be pre-populated with one or more RF communication lines. In a preferred aspect, the packing fraction of the communication lines (i.e., the space occupied by the lines versus the available volume in the conduit portion) is maintained at 50% or less to all for communication lines to be more easily accessed during installation. This lower packing fraction permits pulling slack from the communication lines in the conduit portion. In another preferred aspect, the RF communication lines are configured to transmit RF signals, having a transmission frequency range of from about 300 MHz to about 6 GHz. These fibers can be accessed through the main body and pulled out for use as needed.

While the conduit portion can have a generally circular cross-section, in alternative embodiments it may have another shape, such as a rectangular, square, triangular, oval, or other polygonal shaped cross-section. In a further alternative aspect, the duct 110 can include multiple separate conduits in which communication lines can be houses, with any of the cross-section shapes mentioned above.

In one aspect, duct 110 is a structure formed from a polymeric material, such as a polyolefin, a polyurethane, a polyvinyl chloride (PVC), or the like. For example, in one aspect, duct 110 can comprise an exemplary material such as a polyurethane elastomer, e.g., Elastollan 1185A10FHF. Additives, such as flame retardants, stabilizers, and fillers can also be incorporated as required for a particular application. In a preferred aspect, duct 110 is flexible, so that it can be guided and bent around corners and other structures without cracking or splitting. Duct 110 can be continuously formed using a conventional extrusion process and can have an extended length, only limited by manufacturing and practical constraints.

In an alternative aspect, duct 110 can be formed from a metallic material, such as copper or aluminum. In one aspect, the metallic material may be pre-laminated with a polymer film, such as a liquid crystal polymer or thermoplastic material, having a relatively thin thickness (e.g., up to 2 mils), that forms an outer skin or shell around the main body of the duct. This outer skin can help prevent moisture from penetrating the duct and can also be used as a decorative cover. In addition, a metallic skin may pass certain flammability requirements, where appropriate.

Duct 110 also includes a flange or similar flattened portion to provide support for the duct 110 as it is installed on or mounted to a wall or other mounting surface, such as a floor, ceiling, or molding. In most applications, the mounting surface is generally flat. The mounting surface may have texture or other structures formed thereon. In other applications, the mounting surface may have curvature, such as found with a pillar or column. The flange extends along the longitudinal axis of the duct as shown in FIG. 1A. Exemplary duct 110 includes a double flange structure, with flange portions 115a and 115b, positioned (in use) below the centrally positioned conduit portion. In an alternative aspect, the flange can include a single flange portion. In alternative applications, a portion of the flange can be removed for in-plane and out-of-plane bending.

In a preferred aspect, the flange 115a, 115b includes a channel 119 configured to accommodate a substantially rectangular-shaped (in cross-section view) cable. In one aspect, the substantially rectangular-shaped cable comprises a ribbon cable (see e.g., ribbon cable 106 in FIG. 1B), which provides an additional set of signal channels. In this exemplary aspect, the ribbon cable 106 can be press fit into channel 119. In one aspect, the ribbon cable includes a plurality of electrical wires (e.g., two to eight wires). An example commercially available ribbon cable includes the Model 3801/09 flat cable, available from 3M Company (St. Paul, Minn.). In this manner, as signal channels are routed through a building or structure via duct 110, additional signal, e.g., power, lines can also be routed via the ribbon cable without having to establish an additional horizontal cabling pathway. This type of arrangement can provide for additional wiring for example, for floor distribution unit to floor distribution unit applications, in an aesthetically pleasing manner. Alternatively, the ribbon cable can include a plurality of optical fibers. In a further alternative, the ribbon cable can comprise a shielded electrical cable, such as is described in PCT Publication No. WO 2010/148165, incorporated by reference herein in its entirety. In this manner, duct 110 can provide for the separation of optical and electrical media.

In another aspect, the substantially rectangular-shaped cable can comprise a flexible cable, such as a copper braided cable (e.g., Alpha Wire Part No. 1233) or a rigid cable, cable, such as a flat copper wire, available from FXC (Phoenix, Ariz.). These cables can have a thickness of from about 0.02″ to about 0.04″.

In a preferred aspect, duct 110 has a generally flat surface shape. This flat surface provides a suitable surface area for adhering the duct 110 to a mounting surface, a wall or other surface (e.g., dry wall or other conventional building material) using an adhesive layer 118 (see FIG. 1B).

Optionally, duct 110 can further include a strength member, such as an aramid string or thread (e.g., a woven or non-woven Kevlar material) that is twisted or aramid yarn. The aramid string or aramid yarn can be bonded or un-bonded. Alternative strength member materials include metallic wire or a fiberglass member. The strength member can run lengthwise with the main body of duct 110. The strength member can help prevent elongation and relaxation of the duct during and after installation, where such elongation and relaxation may cause disbondment of the duct from the mounting surface.

In one aspect of the present invention, the adhesive layer 118 can be disposed on a rear side of the rectangular cable, such as ribbon cable 106, such as is shown in FIG. 1B, or on a rear side of flange portions 115a, 115b. The adhesive layer 118 can comprise an adhesive, such as an epoxy, transfer adhesive, acrylic adhesive or double-sided tape. In one aspect, adhesive layer 118 comprises a factory applied 3M VHB 4941F adhesive tape (available from 3M Company, St. Paul Minn.). In another aspect, adhesive layer 118 comprises a removable adhesive, such as a stretch release adhesive. By “removable adhesive” it is meant that the duct 110 can be mounted to a mounting surface (preferably, a generally flat surface, although some surface texture and/or curvature are contemplated) so that the duct 110 remains in its mounted state until acted upon by an installer/user to remove the duct from its mounted position. Even though the duct is removable, the adhesive is suitable for those applications where the user intends for the duct to remain in place for an extended period of time. Suitable removable adhesives are described in more detail in PCT Appl. No. US2011/029715, incorporated by reference herein in its entirety.

In an alternative aspect, adhesive backing layer 118 includes a removable liner (not shown) that is removed upon installation of duct 110 to a mounting surface.

While many of the ducts described herein are shown having a symmetrical shape, the duct designs can be modified to have an asymmetric shape (such as a flange wider on one side than the other), as would be apparent to one of ordinary skill in the art given the present description.

Moreover, the ducts described herein may be coextruded with at least two materials. A first material can exhibit properties that afford protection of the communication lines or other cables within the conduit portion of each duct such as against accidental damage due to impact, compression, or even provide some protection against intentional misuse such as stapling. A second material can provide functional flexibility for cornering.

In some aspects, the ducts can include a V0 flame retardant material, can be formed from a material that is paintable, or in a further alternative, covered with another decorative material.

In another aspect, as shown in FIG. 1C, an adhesive-backed duct 210 accommodates multiple signal channels to provide horizontal cabling for in-building applications and for inside living unit applications. Duct 210 includes a main body 212 having a conduit portion, here bore 213, provided therethrough. The bore 213 is sized to accommodate one or more communication lines disposed therein. In this example, bore 213 is sized to accommodate multiple optical fibers 105. The optical fibers can be optimized for carrying RFoG. For example, the optical fiber can comprise a single mode optical fiber designed to transport native RF signals. Multi-mode fibers can also be utilized in some applications. In an alternative aspect, bore 213 can include one or more coax cables. In a further alternative aspect, bore 213 can accommodate a power line. In another alternative aspect, the adhesive-backed cabling can further include one of more communication channels configured as Ethernet over twisted pair communication lines, such as CAT5e, CAT6, or CAT“X” lines. In another alternative, power can be transmitted over the conducting core of one or more of the coax lines.

Duct 210 can be a structure formed from a polymeric material, such as those described above. In a further aspect, the duct 210 can be directly extruded over the communications lines in an over-jacket extrusion process. Alternatively, duct 210 can be formed from a metallic material, such as copper or aluminum, as described above. Duct 210 can be provided to the installer with or without an access slit.

Duct 210 also includes a flange 215a, 215b or similar flattened portion to provide support for the duct 210. In a preferred aspect, the flange 215a, 215b includes a rear or bottom surface 216 that has a generally flat surface shape. Optionally, duct 210 can include one or more strength members, such as those described above.

In this aspect, a substantially rectangular cable, such as ribbon cable 206, can be disposed on the bottom surface 216 via an adhesive (not shown). Ribbon cable 206 provides an additional set of signal channels. In one aspect, the ribbon cable includes a plurality of electrical wires (e.g., two to eight wires). In this manner, as signal channels are routed through a building or structure via duct 210, additional signal, e.g., power, lines can also be routed without having to establish an additional pathway. This type of arrangement can provide for additional wiring for example, for floor distribution unit to floor distribution unit applications, in an aesthetically pleasing manner. Alternatively, the ribbon cable can include a plurality of optical fibers. In a further alternative, the ribbon cable can comprise a shielded electrical cable, such as is described in PCT Publication No. WO 2010/148165, incorporated by reference above. In addition, the ribbon cable 206 can function as a strength member to help control or limit the stretch of the polymeric duct during installation.

In a preferred aspect, an adhesive layer 218 comprises an adhesive, such as an epoxy, transfer adhesive, acrylic adhesive, pressure sensitive adhesive, double-sided tape, or removable adhesive, such as those described above, disposed on all or at least part of surface 216. Although not shown, a removable liner can be provided and can be removed when the adhesive layer is applied to a mounting surface.

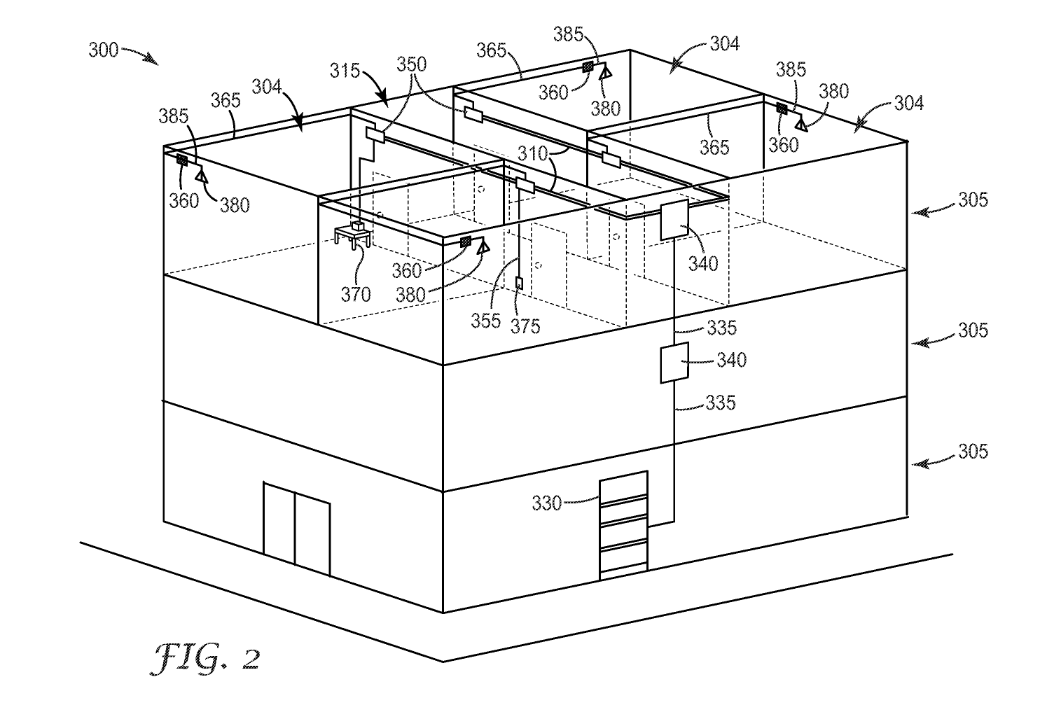

In one exemplary use, the adhesive-backed cabling duct can be used as part of a converged in-building wireless system as shown in FIG. 2. In this aspect, “converged” means that the system accommodates both standard land line telecommunication wiring and wiring for IBW. In this system, the adhesive-backed cabling duct, as described above, can be used as horizontal cabling between area junction boxes or distribution boxes located on each floor and the point of entry boxes located at one or more access points, such as at or near the entryway of a living unit. Additionally, the adhesive-backed cabling duct can carry multiple optical fiber plus power cables within each living unit from the point of entry box to, e.g., a remote radio socket located near each of the distributed antennas.

For example, FIG. 2 shows an exemplary multi-dwelling unit (MDU) 300 having four living units 304 on each floor 305 within the building with two living units located on either side of a central hallway 315.

A feeder cable (not shown) brings wired communications lines to and from MDU 300 from the traditional communication network and coax feeds bring the RF or wireless signals into the building from nearby wireless towers or base stations. All of the incoming lines (e.g. optical fiber, coax, and traditional copper) are fed into a main distribution facility in the basement or equipment closet of the MDU, which is used to organize the signals coming into the building from external networks to the centralized active chassis equipment for the system. Power mains and backup power are typically configured in this main distribution facility. Additionally, fiber and power cable management which supports the indoor wired and wireless networks both into the building from the outside plant and onto the rest of the indoor network distribution system can be located in the main distribution facility. The main distribution facility can include one or more racks 330 to hold equipment chassis as well as telecommunication cable management modules. Exemplary equipment which can be located on the rack in the main distribution facility can include, for example, a plurality of RF signal sources, an RF conditioning drawer, a DAS hub, a power distribution equipment, and DAS remote management equipment. Exemplary telecommunication cable management modules can include, for example, a fiber distribution hub, a fiber distribution terminal or a patch panel.

Riser cables or trunk cables 335 run from the equipment rack 330 in the main distribution facility to the area junction boxes 340 located on each floor 305 of the MDU 300. The area junction box provides the capability to aggregate horizontal fiber runs and optional power cabling on each floor. At the area junction box, trunked cabling is broken out to a number of cabling structures containing optical fibers or other communication cables and power cables which are distributed within the MDU by horizontal cabling 310, which is configured similarly to ducts 110, 210 described above, and which utilizes the adhesive-backed cabling duct designs described herein. A point of entry box 350 is located at each living unit to split off power and communication cables to be used within the living unit.

These cables feed remote radio sockets 360 as well as connections to communication equipment 370 inside of each living unit or a wall receptacle 375 to which a piece of communication equipment can be connected by a patchcord (not shown) through point of entry boxes 350. Exemplary communication equipment can include a single family unit optical network terminal (SFU ONT), desktop ONT, or similar device (e.g., a 7342 Indoor Optical Terminal, available from Alcatel-Lucent or a Motorola ONT1120GE Desktop ONT).

The optical fibers and power cables which feed the remote radio socket can be disposed in a second smaller (i.e. lower cable count) re-enterable telecommunication duct 355, also having an adhesive backing as described herein. Alternatively, the fibers and power cables may be carried in a ducted structure such as that described in U.S. Patent Publication Nos. 2009/0324188 and 2010-0243096, incorporated by reference herein in their entirety.

The remote radio socket 360 can include remote repeater/radio electronics to facilitate a common interface between the active electronics and the structured cabling system. The remote radio socket facilitates plugging in the remote radio electronics which convert the optical RF to electrical signals and further distributes this to the distributed antennas 380 for radiation of the analog RF electrical signal for the IBW distribution system.

The distributed antennas 380 can be connected to the remote radio socket 360 by a short length of coaxial cable 385.

Optical drop fibers can be carried from the point of entry box 350 to an anchor point, such as wall receptacle 375 or a piece of communication equipment 370, via low profile duct 355. In a preferred aspect, the duct 355 can be disposed along a wall, ceiling, under carpet, floor, or interior corner of the living unit in an unobtrusive manner, such that the aesthetics of the living unit are minimally impacted. Exemplary low profile ducts are described in U.S. Patent Publications Nos. 2011-0030832 and 2010-0243096, incorporated by reference herein in their entirety.

The above described adhesive-backed cable configurations can be utilized in a variety of telecommunications and IBW applications with a variety of different architectures, such as the application shown in FIG. 2. Alternatively, the cabling described herein can be used as part of a passive copper coax distribution architecture. In this architecture, the adhesive-backed cabling duct can include one or more radiating coaxial cables. With only a head-end active component, the one or more radiating channels in the adhesive-backed cable obviate the need to implement multiple antennas throughout the building. For example, for installation below a drop ceiling, the generally planar structure of the cable allows radiating apertures to face downward as the cable lays flat against the drop ceiling support structure.

This system can also be implemented with discrete radiating antennas connected to the horizontal coax channels with conventional splitters, taps, and/or couplers. In this manner, multiple service carriers can utilize the adhesive-backed RF signal cabling as horizontal cabling or as part of a radiating antenna system, or both. This type of architecture can work with many different RF protocols (e.g., any cellular service, iDEN, Ev-DO, GSM, UMTS, CDMA, and others).

In another alternative aspect, the adhesive-backed cabling duct can be configured as multi-channel cabling that includes multiple coax cables. For example, separate coax conductors can connect to separate antennas of a multiple-input and multiple-output (MIMO) antenna system, e.g., a 2×2 MIMO antenna system, a 4×4 MIMO antenna system, etc. In another alternative aspect, first and second coax conductors can be coupled to an antenna system with cross-polarized antenna elements.

In another example, the adhesive-backed RF signal cabling described herein can be used as part of an active analog distribution architecture. In this type of architecture, RF signal distribution can be made over coax or fiber (RoF). In this architecture, the cabling can be combined with selected active components, where the types of active components (e.g., O/E converters for RoF, MMIC amplifiers) are selected based on the specific architecture type. This type of architecture can provide for longer propagation distances within the building and can work with many different RF protocols (e.g., any cellular service, iDEN, Ev-DO, GSM, UMTS, CDMA, and others).

Exemplary tooling that can be utilized to mount exemplary adhesive-backed cabling is described in US Pat. Publ. No. 2009-0324188.

The adhesive-backed cabling described herein can also be utilized in other indoor and outdoor applications, and in commercial or residential buildings, such as in office buildings, professional suites, and apartment buildings.

The adhesive-backed cabling described above can be used in buildings where there are a lack of established horizontal pathways from the intermediate distribution frames (IDFs) to an antenna as the cabling can provide radiating coax. In addition, for buildings with drywall ceilings and little or no access panels, the adhesive-backed cabling of the present invention can be installed without having to enter the existing drywall ceiling. Some older buildings may have missing or inaccurate blueprints, thus the adhesive-backed cabling described herein can be installed on the basis of a visual survey. The adhesive-backed cabling helps minimize or eliminate the need to disturb existing elaborate trim and hallway decorum. In addition, the need to establish major construction areas can be avoided.

As described above with respect to the various adhesive-backed RF signal cable embodiments, the cabling of the present invention provides an RF signal distribution medium within a building or other structure that includes multiple channels. Thus, different carriers each needing wireless distribution in a building can utilize the adhesive-backed RF signal cabling, where a common horizontal installation can support different carriers, providing cost savings and carrier autonomy. In addition, different services, such as GSM, UMTS, IDEN, Ev-DO, LTE, and others can be distributed by the adhesive-backed RF signal cabling. Moreover, with the adhesive-backed RF signal cabling configurations discussed above, the effect of passive inter-modulation (PIM) distortion is reduced as separated signal pathways can carry the services operating at different frequencies. Further, the adhesive-backed RF signal cabling can be implemented in various MIMO architectures for multi-path RF environments. In another alternative, the adhesive-backed RF signal cabling can be utilized in a cross-polarization antenna system, which can transmit and receive from a single integrated antenna unit. The adhesive-backed RF signal cabling can provide same-length pathways for phase and delay control.

The adhesive-backed RF signal cabling also provides for routing signals to different locations within a building, such as “lunch room,” “conference room,” “meeting room”, etc. The multiple channel designs also allows for a separate receive channel to be set up independent of the other channels, if needed. This type of configuration can provide for better signal conditioning for getting the user equipment (UE) signal back to the cell site.

Thus, the adhesive-backed signal cable described herein provides for flexible network design and optimization in a given indoor environment.

While the above embodiments are described in relation to standard telecom and IBW applications, the adhesive-backed RF signal cabling of the present invention can also be utilized in outdoor wireless applications as well.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What is claimed is:

1. An adhesive-backed hybrid cabling duct, comprising:
a main body having at least one conduit portion with a bore formed throughout that is sized to accommodate one or more communication lines disposed therein;
a flange to provide support for the duct as it is mounted to a mounting surface, wherein the flange includes a channel formed therein configured to receive a substantially rectangular-shaped cable; and
an adhesive layer to mount the duct to the mounting surface.

2. The adhesive-backed hybrid cabling duct of claim 1, wherein the main body and flange portion are formed from a polymer.

3. The adhesive-backed hybrid cabling duct of claim 2, wherein the polymer is a polymer that is extruded over the one or more communication lines.

4. The adhesive-backed hybrid cabling duct of claim 1, wherein the one or more communication lines disposed in the bore comprise a plurality optical fibers and wherein the substantially rectangular cable comprises a ribbon cable having a plurality of electrical wires.

5. The adhesive-backed hybrid cabling duct of claim 4, wherein the plurality of optical fibers are configured to transmit RF signals having a transmission frequency range of from about 300 MHz to about 6 GHz.

6. The adhesive-backed hybrid cabling duct of claim 1, wherein the one or more communication lines disposed in the bore comprise at least one electrical wire and wherein the substantially rectangular cable comprises a plurality of optical fibers.

7. The adhesive-backed hybrid cabling duct of claim 1, wherein the one or more communication lines disposed in the bore comprise at least one Ethernet over twisted pair communication line.

8. The adhesive-backed hybrid cabling duct of claim 1, wherein the main body includes more than one conduit portion.

9. The adhesive-backed hybrid cabling duct of claim 1, wherein the one or more communications lines occupy 50% or less of the volume within the bore.

10. An adhesive-backed hybrid cabling duct, comprising:
a main body having at least one conduit portion with a bore formed throughout that is sized to accommodate one or more communication lines disposed therein;
a flange to provide support for the duct as it is mounted to a mounting surface;
a substantially rectangular-shaped cable disposed between the flange and the mounting surface; and
an adhesive layer to mount the duct to the mounting surface.

11. The adhesive-backed hybrid cabling duct of claim 10, wherein the main body and flange portion are formed from a polymer.

12. The adhesive-backed hybrid cabling duct of claim 11, wherein the polymer is a polymer that is extruded over the one or more communication lines.

13. The adhesive-backed hybrid cabling duct of claim 10, wherein the one or more communication lines disposed in the bore comprise a plurality optical fibers and wherein the substantially rectangular-shaped cable comprises a ribbon cable having a plurality of electrical wires.

14. The adhesive-backed hybrid cabling duct of claim 13, wherein the plurality of optical fibers are configured to transmit RF signals having a transmission frequency range of from about 300 MHz to about 6 GHz.

15. The adhesive-backed hybrid cabling duct of claim 10, wherein the one or more communication lines disposed in the bore comprise at least one electrical wire and wherein the substantially rectangular-shaped cable comprises a plurality of optical fibers.

16. The adhesive-backed hybrid cabling duct of claim 10, wherein the one or more communication lines disposed in the bore comprise at least one Ethernet over twisted pair communication line.

17. The adhesive-backed hybrid cabling duct of claim 10, wherein the main body includes more than one conduit portion.

18. The adhesive-backed hybrid cabling duct of claim 10, wherein the one or more communications lines occupy 50% or less of the volume within the bore.

19. A distributed system for in-building wireless applications, comprising:
an adhesive-backed hybrid cabling duct, comprising a main body having at least one conduit portion with a bore formed throughout that is sized to accommodate one or more communication lines disposed therein, a flange to provide support for the duct as it is mounted to a mounting surface, wherein the flange includes a channel formed therein configured to receive a substantially rectangular-shaped cable, and an adhesive layer to mount the duct to the mounting surface, wherein the one or more communication lines are configured to transmit RF signals having a transmission frequency range of from about 300 MHz to about 6 GHz.

20. A distributed system for in-building wireless applications, comprising:
an adhesive-backed hybrid cabling duct, comprising a main body having at least one conduit portion with a bore formed throughout that is sized to accommodate one or more communication lines disposed therein, a flange to provide support for the duct as it is mounted to a mounting surface, a substantially rectangular-shaped cable disposed between the flange and the mounting surface, and an adhesive layer to mount the duct to the mounting surface, wherein the one or more communication lines are configured to transmit RF signals having a transmission frequency range of from about 300 MHz to about 6 GHz.
